(19) United States
(12) Patent Application Publication
(10) Pub. No.: US 2024/0104372 A1
(43) Pub. Date: Mar. 28, 2024

(54) SYSTEMS AND METHODS FOR IMPROVING TRAINING OF ARTIFICIAL NEURAL NETWORKS

(71) Applicant: Meta Platforms, Inc., Menlo Park, CA (US)

(72) Inventors: Tigran Ishkhanov, Menlo Park, CA (US); Maxim Naumov, Redwood City, CA (US)

(21) Appl. No.: 17/951,069

(22) Filed: Sep. 22, 2022

(51) Int. Cl. G06N 3/08; G06N 3/04

(52) U.S. Cl. CPC G06N 3/08; G06N 3/0472

(57) ABSTRACT

The disclosed computer-implemented method may include (1) selecting, for training of an artificial neural network (ANN), a training batch of points from within a dataset of training points, each training point comprising a plurality of sets of values, where each value corresponds to an index into an embedding space included in the ANN, (2) forming, from the dataset of training points, a neighborhood of training points associated with the training batch such that each member of the neighborhood shares at least one index with at least one training point included in the training batch, (3) choosing, via a cluster analysis method, a cluster of points from the neighborhood of training points associated with the training batch, and (4) training the ANN using the chosen cluster of points from the neighborhood of points associated with the training batch. Various other methods, systems, and computer-readable media are also disclosed.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for improving training of artificial neural networks.

FIG. 2 is a block diagram of an example implementation of a system for improving training of artificial neural networks.

FIG. 3 is a flow diagram of an example method for improving training of artificial neural networks.

FIG. 4 illustrates training points that may be included as part of a training dataset in accordance with some embodiments described herein.

FIG. 5 illustrates forming a neighborhood of training points associated with a training batch in accordance with some embodiments described herein.

FIG. 6 illustrates training an artificial neural network by freezing rows included in an embedding layer of the artificial neural network except rows that correspond to at least one index included in a training batch in accordance with some embodiments described herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

Artificial neural networks are computing systems inspired by biological neural networks. Artificial neural networks may “learn” to perform tasks by processing example or training data, often without being pre-programmed with task-specific rules. An effectively trained artificial neural network can be a powerful tool to aid in modern computing tasks such as pattern recognition, process control, data analysis, social filtering, and so forth.

An example of training of an artificial neural network from a given example may include determining a difference (e.g., error) between a processed output of the artificial neural network (e.g., a predicted result) and a target output. A training system may then adjust internal probability-weighted associations of the artificial neural network according to a learning rule and the difference between the processed output and the target output. Successive adjustments may cause the artificial neural network to produce output that is increasingly similar to the target output.

Some modern artificial neural networks may include a collection of connected units or nodes organized and/or aggregated into various layers. Different layers may perform different transformations on input signals, with signals provided to an input layer possibly traversing several intermediate layers before reaching an output layer.

One or more layers in an artificial neural network may include an embedding layer. An embedding layer or embedding matrix may translate and/or convert categorical data into numerical vectors. Such embedding layers may capture and/or reflect similarities among inputs in a multidimensional space, and also may be updated during training of the artificial neural network.

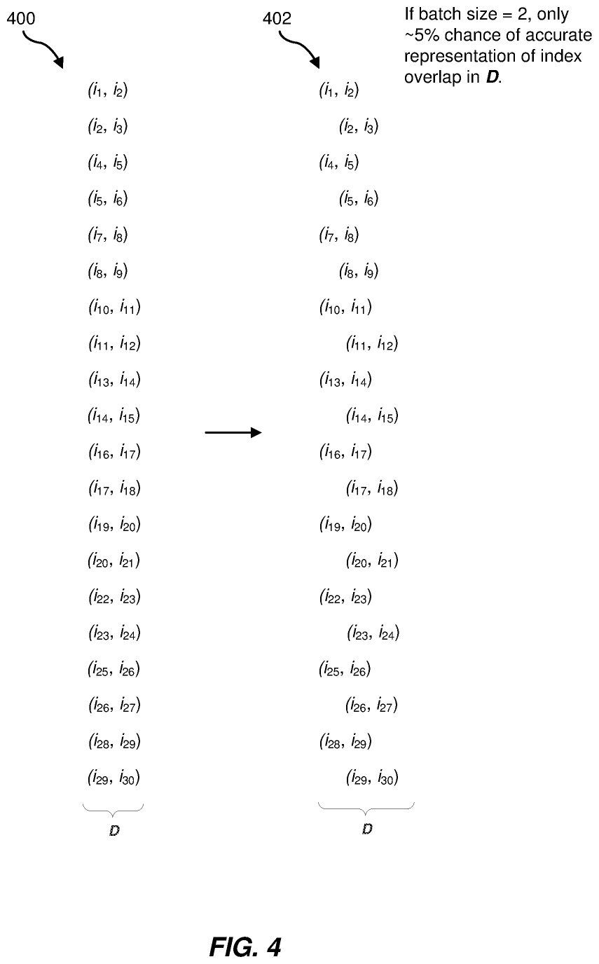

Training of embedding layers generally involves selecting batches B of training data from a training dataset D. Conventional batch construction may call for selecting uniformly random points within the training dataset. In such examples, a statistical distance (e.g., a Wasserstein distance) between a batch B and a full data distribution D may be small, but an index overlap pattern between points may be very different for B as compared to D. The index overlap may be thought of as “degrees of freedom” (DoF) in an embedding space E. The more overlap there is between points, the lower the DoF in an embedding layer or E-layer. If B has a much larger DoF as compared to D and training of the E-layer is not restricted, embedding weights (or E-weights) in the E-layer may adjust during training to accommodate B, potentially impacting or hurting E-weights overall (e.g., overfitting the embedding layer to B). An illustration of this issue is provided below in reference to FIG. 4.

Another potential problem with conventional batch construction that may impact test accuracy may involve selection of points for inclusion in B that may share some, but not all, indices with other points in B. By way of illustration, consider a point x that shares some but not all indices with some other pointy in batch B, but is not itself in B. When batch B is used for training of the E-layer, the shared indices in x are adjusted in the embedding space E while the rest of indices in x remain fixed. Since the point x is not used by a loss function during training of B, the value of model M on x may be negatively impacted by this training iteration.

The present disclosure is generally directed to systems and methods for improving training of artificial neural networks. As will be explained in greater detail below, embodiments of the instant disclosure may select, for training of an artificial neural network, a training batch (e.g., B) of points from within a dataset (e.g., D) of training points. Each training point may include a plurality of sets of values, and each value may correspond to an index into an embedding space (e.g., E) that is part of the artificial neural network. Embodiments may also form, from the dataset of training points, a neighborhood (e.g., N(B)) of training points associated with the training batch. Each member of the formed neighborhood may share at least one index with at least one training point included in the training batch. Embodiments may further choose, via a cluster analysis method, a cluster of points (e.g., N(B, k)) from the neighborhood of training points associated with the training batch and may train the artificial neural network using the chosen cluster of points from the neighborhood of training points associated with the training batch. In some examples, the cluster analysis method may include a k-means clustering method, a k-nearest neighbor classifier, a nearest centroid classifier, a support vector machine classifier, a native Bayes classifier, or any other clustering method based on distance (e.g., Hamming distance). Furthermore, in some examples, the training happens by performing a forward propagation on all training points in N(B, k) and computing associated loss, while performing backward propagation and weight updated only on training points in B. This approach may be similar or equivalent to freezing weights in an embedding layer of the artificial neural network that correspond to an index included in a cluster of points N(B, k)), but not in B.

The systems and methods described herein may improve training of artificial neural networks in many ways. For example, by training N(B, k) instead of B on a union of all indices included in B (or I(B)), the systems and methods described herein may train the same set of weights as in conventional batch selection, but with the loss function aware of points in D that may be adversely impacted by the training iteration (i.e., points close to points in B in both the index and embedding spaces). This may combat overfitting of the embedding layer E and/or the overall model M to the training data included in the training dataset D. Hence, embodiments of the systems and methods described herein may improve training of and/or predictive capabilities of artificial neural networks.

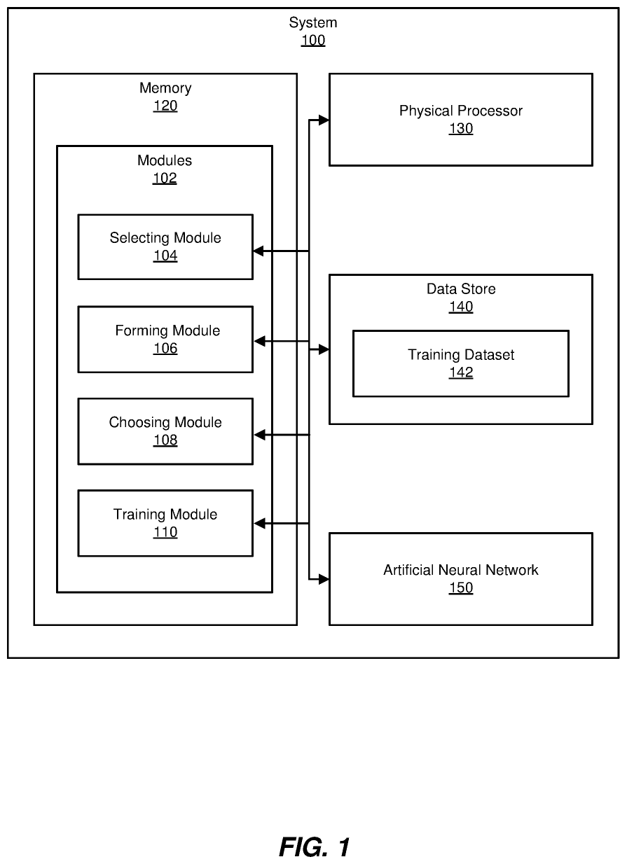

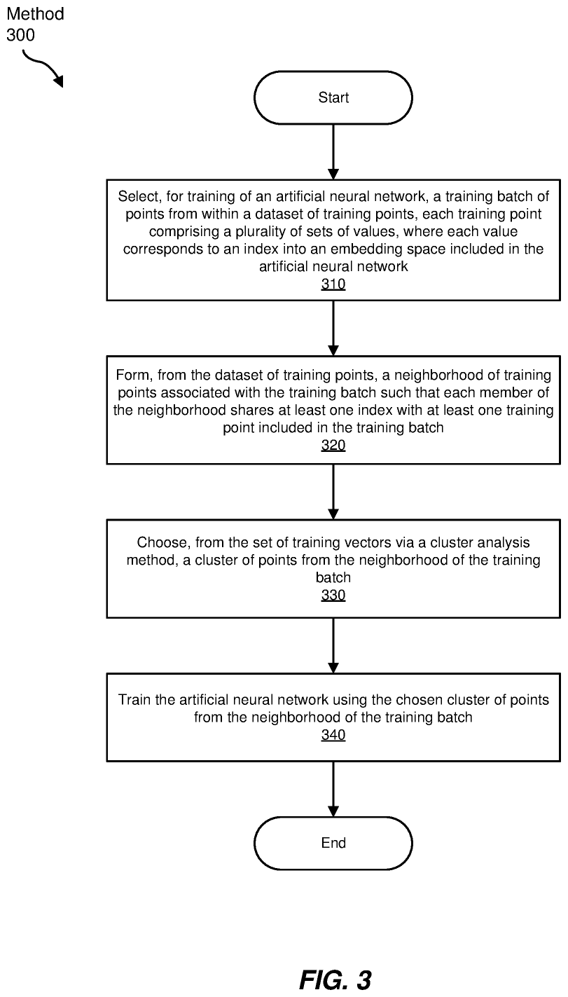

The following will provide, with reference to FIGS. 1-2 and 4-6, detailed descriptions of systems for improving training of artificial neural networks. Detailed descriptions of corresponding computer-implemented methods will also be provided in connection with FIG. 3.

FIG. 1 is a block diagram of an example system 100 for improving training of artificial neural networks. As illustrated in this figure, example system 100 may include one or more modules 102 for performing one or more tasks. As will be explained in greater detail below, modules 102 may include a selecting module 104 that selects, for training of an artificial neural network, a training batch of points from within a dataset of training points. Each training point may include multiple sets of values, where each value may correspond to an index into an embedding space that is part of the artificial neural network.

As also shown in FIG. 1, example system 100 may also include, as part of modules 102, a forming module 106 that forms, from the dataset of training points, a neighborhood of training points associated with the training batch such that each member of the neighborhood shares at least one index with at least one training point included in the training batch.

Moreover, example system 100 may also include, as part of modules 102, a choosing module 108 that chooses, via a cluster analysis method, a cluster of points from the neighborhood of the training batch, and a training module 110 that trains the artificial neural network using the chosen cluster of points from the neighborhood of points associated with the training batch.

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate improving training of artificial neural networks. Examples of physical processor 130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also shown in FIG. 1, example system 100 may also include one or more datastores, such as data store 140, that may receive, store, and/or maintain data. In at least one example, data store 140 may include at least one training dataset 142. Data store 140 may represent portions of a single data store or computing device or a plurality of data stores or computing devices. In some embodiments, data store 140 may be a logical container for data and may be implemented in various forms (e.g., a database, a file, a file system, a data structure, etc.). Examples of data store 140 may include, without limitation, files, file systems, data stores, databases, and/or database management systems such as an operational data store (ODS), a relational database, a NoSQL database, a NewSQL database, and/or any other suitable organized collection of data.

Training dataset 142 may include any suitable data and/or data structure for training of an artificial neural network. In some examples, training dataset 142 may include one or more data points. Each data point may include and/or represent any suitable data and/or data structure including, without limitation, a single value, a set of values, a single dimensional vector, a multidimensional vector, a tensor, and/or any other suitable data and/or data structure(s) that may be used to train an artificial neural network to perform a task.

As further shown in FIG. 1, example system 100 may include an artificial neural network 150. In some embodiments, an artificial neural network may include any software and/or hardware composed of interconnected processing nodes. These processing nodes, which may be referred to as “artificial neurons,” may receive inputs and pass outputs to other artificial neurons. The output of each artificial neuron may be determined by a non-linear function combination of each input to the artificial neuron, and each connection between artificial neurons may be assigned a “weight” that determines the degree to which a particular connection contributes to the output of the destination neuron(s). Artificial neural networks may be used in a variety of contexts, including, without limitation, computer vision (e.g., image recognition and object detection), natural language processing (e.g., translation and speech recognition), medical diagnosis and recommendation systems. Artificial neural networks may be implemented in a variety of ways. In some embodiments, an artificial neural network may be implemented as software programs and/or any other suitable form of computer-readable instructions that are executed on one or more physical processors. In further embodiments, an artificial neural network may be implemented in physical hardware, such as a series of interconnected physical processors with each processor unit acting as an artificial neuron. Hence, although some examples described herein may explain and/or illustrate artificial neural network 150 in the context of a software-implemented artificial neural network, artificial neural network 150 may, in some examples, be implemented in any suitable physical hardware.

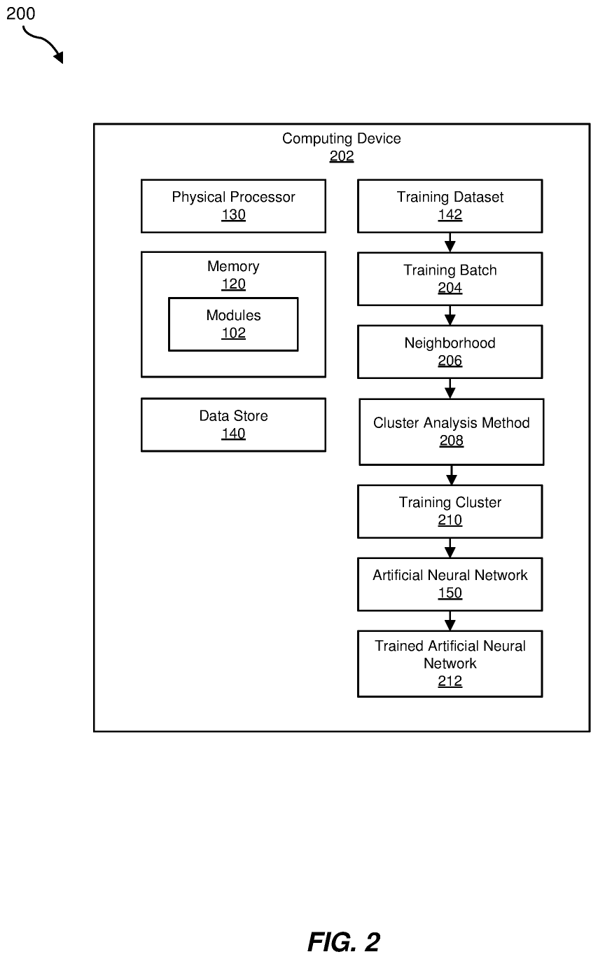

Example system 100 in FIG. 1 may be implemented in a variety of ways. For example, all or a portion of example system 100 may represent portions of an example system 200 (“system 200”) in FIG. 2. As shown in FIG. 2, system 200 may include a computing device 202. In at least one example, computing device 202 may be programmed with one or more of modules 102.

In at least one embodiment, one or more of modules 102 from FIG. 1 may, when executed by computing device 202, enable computing device to perform one or more operations to improve training of artificial neural networks. For example, as will be described in greater detail below, selecting module 104 may cause computing device 202 to select, for training of an artificial neural network (e.g., artificial neural network 150), a training batch of points (e.g., training batch 204, also B herein) from within a dataset of training points (e.g., training dataset 142, also D herein). Additionally, forming module 106 may cause computing device 202 to form, from the dataset of training points, a neighborhood of training points (e.g., also N(B) herein) associated with the training batch such that each member of the neighborhood shares at least one index with at least one training point included in the training batch.

Moreover, choosing module 108 may cause computing device 202 to choose, via a cluster analysis method (e.g., cluster analysis method 208), a cluster of points from the neighborhood of training points associated with the training batch (e.g., training cluster 210, also N(B, k) herein), and training module 110 may train the artificial neural network using the chosen cluster of points from the neighborhood of the training batch by freezing some of the indices not in the training batch. In some examples, this training may result in a new, trained artificial neural network, while in additional or alternative examples, this may result in an artificial neural network (e.g., artificial neural network 150) reaching, achieving, and/or assuming a trained state. This resultant trained artificial neural network may be represented in FIG. 2 as trained artificial neural network 212.

Computing device 202 generally represents any type or form of computing device capable of reading and/or executing computer-executable instructions and/or hosting executables. Examples of computing device 202 include, without limitation, application servers, storage servers, database servers, web servers, and/or any other suitable computing device configured to run certain software applications and/or provide various application, storage, and/or database services.

In at least one example, computing device 202 may be a computing device programmed with one or more of modules 102. All or a portion of the functionality of modules 102 may be performed by computing device 202 and/or any other suitable computing system. As will be described in greater detail below, one or more of modules 102 from FIG. 1 may, when executed by at least one processor of computing device 202, may enable computing device 202 to improve training of artificial neural networks.

Many other devices or subsystems may be connected to system 100 in FIG. 1 and/or system 200 in FIG. 2. Conversely, all of the components and devices illustrated in FIGS. 1 and 2 need not be present to practice the embodiments described and/or illustrated herein. The devices and subsystems referenced above may also be interconnected in different ways from those shown in FIG. 2. Systems 100 and 200 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 3 is a flow diagram of an example computer-implemented method 300 for allocating shared resources in multi-tenant environments. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may select, for training of an artificial neural network, a training batch of points from within a dataset of training points. For example, selecting module 104 may, as part of computing device 202, cause computing device 202 to select, for training of artificial neural network 150, training batch 204 from training dataset 142. Each training point may include multiple sets of values, where each value may correspond to an index into an embedding space that is part of the artificial neural network.

Selecting module 104 may select training batch 204 from training dataset 142 in a variety of ways and/or contexts. For example, selecting module 104 may partition training dataset 142 into a plurality of batches based on a predefined batch size, a predetermined selection heuristic, a partitioning method, and so forth. Selecting module 104 may then select training batch 204 from among the plurality of batches. In some examples, selecting module 104 may select training batch 204 in a pseudorandom, disjoint fashion from among data points included in training dataset 142.

As noted above, although referred to as “points” herein, the data included in training dataset 142 may include and/or represent any suitable set of data that may be used to train an artificial neural network (e.g., artificial neural network 150). The data within training dataset 142 may be represented, organized, and/or stored in accordance with any suitable data storage method and may include one or more logical subdivisions. In some examples, training dataset 142 may include one or more vectors, arrays, and/or other data structures that may include or represent multiple suitable values. In at least one example, each training point included in training dataset 142 may include and/or represent a multidimensional vector of values that may each include indexed categorical data associated with one or more categories represented within and/or by at least a portion of artificial neural network 150.

By way of illustration, training dataset 400 in FIG. 4 shows a simplified training dataset D that includes 20 points, each having two indices: (i₁, i₂), (i₂, i₃), (i₄, i₅), (i₅, i₆) . . . (i₂₈, i₂₉), (i₂₉, i₃₀).

As also shown in FIG. 4, training dataset 402 is training dataset 400 arranged to show overlap of indices include in the training points of D. In this example, there are ten pairs of points that each have one overlapping index. As mentioned above, conventional batch construction may call for selecting uniformly random points within the training dataset. In such examples, a statistical distance (e.g., a Wasserstein distance) between a batch B and a full data distribution D may be small, but an index overlap pattern between points may be very different for B as compared to D. The more overlap there is between points, the lower the DoF in an embedding layer or E-layer.

In the example illustrated by training dataset 402 in FIG. 4, if a training batch B of size two is selected in a uniformly random fashion from training dataset 402, there may be only a five percent chance that the selected training batch will resemble the index overlap pattern of D. In approximately ninety five percent of cases, two points of B will have no overlap. During training, a model may move the index values freely in the embedding space to achieve perfect accuracy at the expense of the overall accuracy on D.

Returning to FIG. 3, at step 320, one or more of the systems described herein may form, from a dataset of training points, a neighborhood of training points associated with the training batch such that each member of the neighborhood shares at least one index with at least one training point included in the training batch. For example, forming module 106 may, as part of computing device 202, cause computing device 202 to form a neighborhood 206 (also N(B) herein) of training points associated with training batch 204 such that each member of neighborhood 206 shares at least one index with at least one training point included in training batch 204.

Forming module 106 may form neighborhood 206 in a variety of contexts. For example, forming module 106 may form neighborhood 206 by considering all points in training dataset 142 that share at least one index with some point in training batch 204. Forming of neighborhood 206 may enable one or more of modules 102 to choose a subset of the neighborhood for training of artificial neural network 150.

In alternative terms, if D represents a topological space and p is a point in D, then a neighborhood of p is a subset V of D that includes an open set U containing p:

p∈U⊆V⊆D

Equivalently, the point p E D may belong to a topological interior of V in D. Hence, when considering an index space of training dataset 142, neighborhood 206 of training batch 204 may be a set of points in training dataset 142 that share at least one index with at least one point in training batch 204.

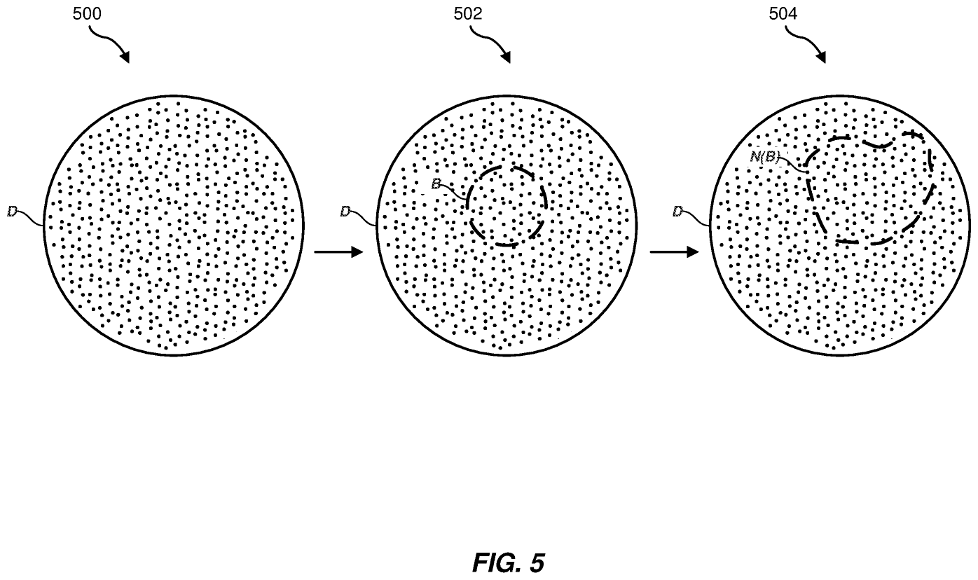

FIG. 5 illustrates forming a neighborhood of training points associated with a training batch in accordance with some embodiments described herein. Note that, while the examples illustrated in FIG. 5 are presented in only two dimensions, a suitable training dataset (e.g., training dataset 142) may include points having any suitable dimensionality corresponding to any suitable data structure. Furthermore, the illustrations shown in FIG. 5 are provided as examples only and are not intended to limit the scope of this disclosure.

View 500 shows a dataset D that includes a plurality of points. View 502 shows a training batch B that may be selected in any suitable way, such as any way described herein in reference to operations of selecting module 104. View 504 shows a neighborhood N(B) of points in training dataset D that may share at least one index with at least one point in training batch B.

Returning to the simplified example shown in FIG. 4, assuming a training batch of size=2, one or more of modules 102 (e.g., selecting module 104) may select a training batch 204 that includes points (i₁, i₂) and (i₁₇, i₁₈). Forming module 106 may then form a neighborhood 206 that includes all points in training dataset 142 (e.g., D in FIG. 4) that share at least one index with at least one point in the training batch 204. Hence, an example neighborhood 206 may include points (i₁, i₂), (i₂, i₃), (i₁₆, i₁₇), and (i₁₇, i₁₈).

Returning to FIG. 3, at step 330, one or more of the systems described herein may choose, via a cluster analysis method, a cluster of points from the neighborhood of training points associated with the training batch. For example, choosing module 108 may, as part of computing device 202, cause computing device 202 to choose, via cluster analysis method 208, a training cluster 210 of points from neighborhood 206.

In some examples, a “cluster analysis method” may include any suitable method or algorithm that groups objects (e.g., training points included in training dataset 142 and/or neighborhood 206) in such a way that objects included in one group are more similar to each other than to objects included in a second group. Cluster analysis method 208 may include any suitable cluster analysis method that may be applied within a relevant data space included in training dataset 142. For example, as described above, training dataset 142 may include and/or represent an indexing space for an embedding layer and/or an embedding space. Hence, a suitable cluster analysis method 208 may be applied within the embedding space of neighborhood 206 to classify and/or cluster data points within neighborhood 206. In some examples, cluster analysis method 208 may include, without limitation, a k-means clustering method, a k-nearest neighbor classifier, a nearest-centroid classifier, a nearest centroid classifier, a support vector machine classifier, a native Bayes classifier, and so forth.

Choosing module 108 may therefore, for example, apply cluster analysis method 208 within an embedding space by using a k-means clustering method within an embedding space of neighborhood 206 to identify a training cluster 210 of points from neighborhood 206. In some examples, training cluster 210 may be referred to as set N(B, k) herein and may be thought of as a neighborhood of training batch 204 (B) in both an index space and embedding space of training dataset 142 (D).

Returning to FIG. 3, at step 340, one or more of the systems described herein may train an artificial neural network using a chosen cluster of points from a neighborhood of points associated with a training batch by freezing some of the indices not in the training batch. For example, training module 110 may, as part of computing device 202, cause computing device 202 to train artificial neural network 150 using training cluster 210 (N (B, k)).

Training module 110 may train artificial neural network 150 in a variety of contexts. For example, as noted above, artificial neural network 150 may include an embedding layer. Hence, Training module 110 may train artificial neural network 150 by training the embedding layer. The embedding layer may include a matrix (i.e., a multidimensional data structure) that may include a number of rows of index weights that may correspond to indices included in training dataset 142.

In some examples, training module 110 may train the embedding layer by adjusting only portions of the embedding layer. For example, training module 110 may train artificial neural network 150 using training cluster 210 (N(B, k)) by freezing one or more weights in the embedding layer during a training operation.

For example, training module 110 may train the embedding layer by freezing elements that are in a set F=N(B, k)−B. In other words, in some examples, frozen set F may include elements that belong to N(B, k), but that are not in B. In other words, in some examples, training module 110 may train the embedding layer by freezing rows corresponding to indices in a difference between sets N(B, k) and B.

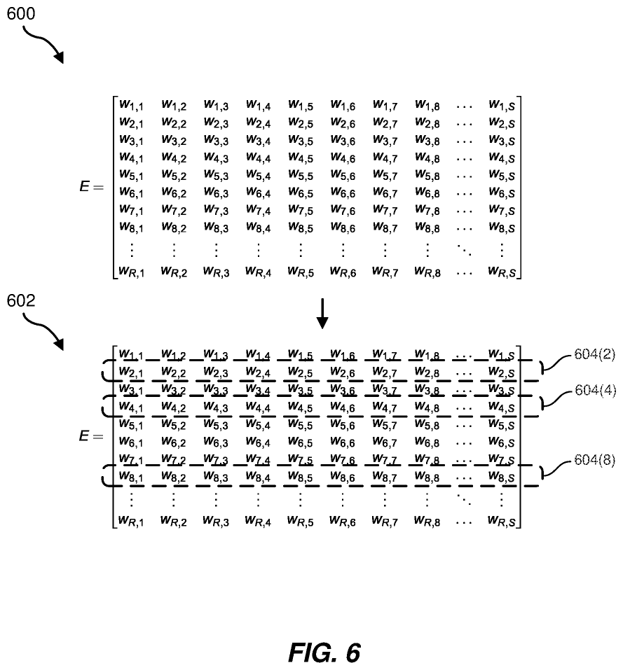

In some additional or alternative examples, training module 110 may freeze index weights in the embedding layer during training of the artificial neural network by freezing rows in the matrix except rows that correspond to at least one index included in training batch 204 (B). By way of illustration, FIG. 6 shows an embedding layer 600 that includes a matrix E of weights. In this example, E may represent an embedding layer with indices in range of [1, R] and each vector of S weights corresponding to it. Hence, E is shown with R rows and S columns.

As also shown in FIG. 6 at view 602, during training of an artificial neural network that includes embedding layer 600, training module 110 may freeze rows included in embedding layer 600 that correspond to at least one index included in a cluster of points N(B, k). In this example, a training batch 204 (B) may include indices corresponding to rows 604 (e.g., row 604(2), row 604(4), and row 604(8)). Hence, during training of embedding layer 600, using training cluster 210, training module 110 may freeze all rows in embedding layer 600 except rows 604.

As discussed throughout the instant disclosure, by training N(B, k) instead of B on I(B), the systems and methods described herein may train the same set of weights as in a conventional case, but with a loss function (i.e., a loss function associated with the artificial neural network and/or an embedding layer included in the artificial neural network) aware of training points and/or weights that may be adversely impacted by a training iteration, provided that the training points are close to training points in B in both the index space and embedding space. This may combat and/or reduce overfitting of a model (e.g., a model included in and/or represented by an artificial neural network) to particular training data and may therefore improve training of artificial neural networks.

The following example embodiments are also included in this disclosure:

Example 1: A computer-implemented method comprising (1) selecting, for training of an artificial neural network, a training batch of points from within a dataset of training points, each training point comprising a plurality of sets of values, where each value corresponds to an index into an embedding space included in the artificial neural network, (2) forming, from the dataset of training points, a neighborhood of training points associated with the training batch such that each member of the neighborhood shares at least one index with at least one training point included in the training batch, (3) choosing, via a cluster analysis method, a cluster of points from the neighborhood of training points associated with the training batch, and (4) training the artificial neural network using the chosen cluster of points from the neighborhood of points associated with the training batch.

Example 2: The computer-implemented method of example 1, wherein the artificial neural network comprises an embedding layer.

Example 3: The computer-implemented method of example 2, wherein the embedding layer comprises a matrix comprising a number of rows of index weights corresponding to a number of indices included in the dataset of training points.

Example 4: The computer-implemented method of example 3, wherein training the artificial neural network using the chosen cluster of points comprises freezing at least one weight in the embedding layer during training of the artificial neural network.

Example 5: The computer-implemented method of example 4, wherein freezing index weights in the embedding layer during training of the artificial neural network comprises freezing rows included in the embedding layer except rows that correspond to at least one index included in the training batch.

Example 6: The computer-implemented method of any of examples 1-5, wherein choosing, from the set of training points via the cluster analysis method, the cluster of points from the neighborhood of the training batch comprises applying the cluster analysis method within an embedding space of the artificial neural network for each point in the neighborhood of the training batch.

Example 7: The computer-implemented method of any of examples 1-6, wherein the cluster analysis method comprises a k-nearest neighbor classifier.

Example 8: The computer-implemented method of any of examples 1-7, wherein the cluster analysis method comprises a nearest centroid classifier.

Example 9: The computer-implemented method of any of examples 1-8, wherein the cluster analysis method comprises a support vector machine classifier.

Example 10: The computer-implemented method of any of examples 1-9, wherein the cluster analysis method comprises a native Bayes classifier.

Example 11: The computer-implemented method of any of examples 1-10, wherein the cluster analysis method comprises a clustering method based on distance.

Example 12: A system comprising (1) a selecting module, stored in memory, that selects, for training of an artificial neural network, a training batch of points from within a dataset of training points, each training point comprising a plurality of sets of values, where each value corresponds to an index into an embedding space included in the artificial neural network, (2) a forming module, stored in memory, that forms, from the dataset of training points, a neighborhood of training points associated with the training batch such that each member of the neighborhood shares at least one index with at least one training point included in the training batch, (3) a choosing module, stored in memory, that chooses, via a cluster analysis method, a cluster of points from the neighborhood of training points associated with the training batch, (4) a training module, stored in memory, that trains the artificial neural network using the chosen cluster of points from the neighborhood of the training batch, and (5) at least one physical processor that executes the selecting module, the forming module, the choosing module, and the training module.

Example 13: The system of example 12, wherein the artificial neural network comprises an embedding layer.

Example 14: The system of example 13, wherein the embedding layer comprises a matrix comprising a number of rows of index weights corresponding to indices included in the dataset of training points.

Example 15: The system of example 14, wherein the training module trains the artificial neural network using the chosen cluster of points by freezing at least one weight in the embedding layer during training of the artificial neural network.

Example 16: The system of example 15, wherein freezing index weights in the embedding layer during training of the artificial neural network comprises freezing rows included in the embedding layer except rows that correspond to an index included in the training batch.

Example 17: The system of any of examples 12-16, wherein the choosing module chooses, from the set of training points via the cluster analysis method, the cluster of points from the neighborhood of the training batch by applying the cluster analysis method within an embedding space of the artificial neural network for each point in the neighborhood of the training batch.

Example 18: The system of any of examples 12-17, wherein the cluster analysis method comprises at least one of (1) a k-nearest neighbor classifier, (2) a nearest centroid classifier, (3) a support vector machine classifier, (4) a native Bayes classifier, or (5) a clustering method based on distance.

Example 19: A non-transitory computer-readable medium comprising computer-readable instructions that, when executed by at least one processor of a computing system, cause the computing system to (1) select, for training of an artificial neural network, a training batch of points from within a dataset of training points, each training point comprising a plurality of sets of values, where each value corresponds to an index into an embedding space included in the artificial neural network, (2) form, from the dataset of training points, a neighborhood of training points associated with the training batch such that each member of the neighborhood shares at least one index with at least one training point included in the training batch, (3) choose, via a cluster analysis method, a cluster of points from the neighborhood of training points associated with the training batch, and (4) train the artificial neural network using the chosen cluster of points from the neighborhood of training points associated with the training batch.

Example 20: The non-transitory computer-readable medium of example 19, wherein the computer-readable instructions, when executed by the processor of the computing system, cause the computing system to choose, from the set of training vectors via the cluster analysis method, the cluster of points from the neighborhood of the training batch by applying the cluster analysis method within an embedding space of the artificial neural network for each point in the training batch.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive training data to be transformed, transform the training data, output a result of the transformation to train an artificial neural network, use the result of the transformation to make one or more predictions using the trained artificial neural network, and store the result of the transformation to perform one or more additional predictions using the trained artificial neural network and/or further train the artificial neural network. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Discs (CDs), Digital Video Discs (DVDs), and BLU-RAY discs), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
selecting, for training of an artificial neural network, a training batch of points from within a dataset of training points, each training point comprising a plurality of sets of values, where each value corresponds to an index into an embedding space included in the artificial neural network;
forming, from the dataset of training points, a neighborhood of training points associated with the training batch such that each member of the neighborhood shares at least one index with at least one training point included in the training batch;
choosing, via a cluster analysis method, a cluster of points from the neighborhood of training points associated with the training batch; and
training the artificial neural network using the chosen cluster of points from the neighborhood of points associated with the training batch.

2. The computer-implemented method of claim 1, wherein the artificial neural network comprises an embedding layer.

3. The computer-implemented method of claim 2, wherein the embedding layer comprises a matrix comprising a number of rows of index weights corresponding to a number of indices included in the dataset of training points.

4. The computer-implemented method of claim 3, wherein training the artificial neural network using the chosen cluster of points comprises freezing at least one weight in the embedding layer during training of the artificial neural network.

5. The computer-implemented method of claim 4, wherein freezing index weights in the embedding layer during training of the artificial neural network comprises freezing rows included in the embedding layer except rows that correspond to at least one index included in the training batch.

6. The computer-implemented method of claim 1, wherein choosing, from the set of training points via the cluster analysis method, the cluster of points from the neighborhood of the training batch comprises applying the cluster analysis method within an embedding space of the artificial neural network for each point in the neighborhood of the training batch.

7. The computer-implemented method of claim 1, wherein the cluster analysis method comprises a k-nearest neighbor classifier.

8. The computer-implemented method of claim 1, wherein the cluster analysis method comprises a nearest centroid classifier.

9. The computer-implemented method of claim 1, wherein the cluster analysis method comprises a support vector machine classifier.

10. The computer-implemented method of claim 1, wherein the cluster analysis method comprises a native Bayes classifier.

11. The computer-implemented method of claim 1, wherein the cluster analysis method comprises a clustering method based on distance.

12. A system comprising:
a selecting module, stored in memory, that selects, for training of an artificial neural network, a training batch of points from within a dataset of training points, each training point comprising a plurality of sets of values, where each value corresponds to an index into an embedding space included in the artificial neural network;
a forming module, stored in memory, that forms, from the dataset of training points, a neighborhood of training points associated with the training batch such that each member of the neighborhood shares at least one index with at least one training point included in the training batch;
a choosing module, stored in memory, that chooses, via a cluster analysis method, a cluster of points from the neighborhood of training points associated with the training batch;
a training module, stored in memory, that trains the artificial neural network using the chosen cluster of points from the neighborhood of the training batch; and
at least one physical processor that executes the selecting module, the forming module, the choosing module, and the training module.

13. The system of claim 12, wherein the artificial neural network comprises an embedding layer.

14. The system of claim 12, wherein the embedding layer comprises a matrix comprising a number of rows of index weights corresponding to indices included in the dataset of training points.

15. The system of claim 13, wherein the training module trains the artificial neural network using the chosen cluster of points by freezing at least one weight in the embedding layer during training of the artificial neural network.

16. The system of claim 14, wherein freezing index weights in the embedding layer during training of the artificial neural network comprises freezing rows included in the embedding layer except rows that correspond to an index included in the training batch.

17. The system of claim 12, wherein the choosing module chooses, from the set of training points via the cluster analysis method, the cluster of points from the neighborhood of the training batch by applying the cluster analysis method within an embedding space of the artificial neural network for each point in the neighborhood of the training batch.

18. The system of claim 12, wherein the cluster analysis method comprises at least one of:
a k-nearest neighbor classifier;
a nearest centroid classifier;
a support vector machine classifier;
a native Bayes classifier; or
a clustering method based on distance.

19. A non-transitory computer-readable medium comprising computer-readable instructions that, when executed by at least one processor of a computing system, cause the computing system to:
select, for training of an artificial neural network, a training batch of points from within a dataset of training points, each training point comprising a plurality of sets of values, where each value corresponds to an index into an embedding space included in the artificial neural network;
form, from the dataset of training points, a neighborhood of training points associated with the training batch such that each member of the neighborhood shares at least one index with at least one training point included in the training batch;
choose, via a cluster analysis method, a cluster of points from the neighborhood of training points associated with the training batch; and
train the artificial neural network using the chosen cluster of points from the neighborhood of training points associated with the training batch.

20. The non-transitory computer-readable medium of claim 19, wherein the computer-readable instructions, when executed by the processor of the computing system, cause the computing system to choose, from the set of training vectors via the cluster analysis method, the cluster of points from the neighborhood of the training batch by applying the cluster analysis method within an embedding space of the artificial neural network for each point in the training batch.
